(19) United States
(12) Patent Application Publication
(10) Pub. No.: US 2025/0187474 A1
(43) Pub. Date: Jun. 12, 2025

(54) BATTERY-EMBEDDED DEVICE AND METHOD FOR PROVIDING POWER USING THE SAME

(71) Applicants: Hyundai Motor Company, Seoul (KR); Kia Corporation, Seoul (KR)

(72) Inventor: JinSu Jang, Hwaseong-si (KR)

(21) Appl. No.: 18/916,351

(22) Filed: Oct. 15, 2024

(30) Foreign Application Priority Data
Dec. 11, 2023 (KR) 10-2023-0178630

(51) Int. Cl. B60L 53/62; B60L 53/16; B60L 53/35; B60L 53/66; B60L 58/12

(52) U.S. Cl. CPC B60L 53/62; B60L 53/16; B60L 53/35; B60L 53/66; B60L 58/12

(57) ABSTRACT

In an automatic charging device underbody (ACDU) system including a vehicle unit (VU) mounted on a vehicle and a ground unit (GU) installed on the ground and forming an electrical connection to the VU to transmit charging power to the vehicle, the battery-embedded device for supplying power to the GU can include: an inlet to which a connector of a charger can be connected; a power transmission line for transmitting power provided from the charger to the GU through the inlet; a control pilot (CP) circuit for communication with the charger and the GU; a proximity detection (PD) circuit for detecting a connection to the connector of the charger; a rechargeable internal battery providing power to the GU; and a processor monitoring a voltage of the internal battery, and charging the internal battery when a state of charge (SOC) of the internal battery is smaller than a first reference.

### CROSS-REFERENCE TO RELATED APPLICATIONS

This application claims priority to and the benefit of Korean Patent Application No. 10-2023-0178630 filed in the Korean Intellectual Property Office on Dec. 11, 2023, the entire contents of which are incorporated herein by reference.

### TECHNICAL FIELD

The present disclosure relates to a battery-embedded device and a method for providing power using the same.

### BACKGROUND

In accordance with global trends such as regulating exhaust gas emissions of internal combustion locomotives and introducing eco-friendly vehicles, the production of internal combustion locomotives is being reduced and the transition to electric vehicles is taking place. Accordingly, the construction of infrastructure for charging electric vehicles is also actively underway.

However, a time required to charge an electric vehicle is longer than a time required to fuel an internal combustion engine, and there is a risk of electric shock, and a weight of a charging coupler and a weight of a cable increase due to an increase in size of a charger according to an increase in size of a battery, which may cause a decrease in convenience of operation. In addition, there is a need to increase operational efficiency and convenience when various users, such as women, old and weak people, and disabled people, use charging stations. In addition, if the number of autonomous driving-based unmanned vehicles increases in the future, it will be difficult to use a manual connection that needs to be performed by the user.

Accordingly, an automatic charging device (ACD) technology is attracting attention. The ACD is defined as a technology that enables automatic charging without a driver exiting the vehicle when approaching a charger, and may be broadly classified into wireless charging, automatic charging device underbody (ACDU), and automatic charging device sidebody (ACDS). Among them, the ACDU may be a type in which a vehicle unit (VU) is implemented to provide a dedicated connector at the bottom of an electric vehicle, and the connector is brought into contact with a ground unit (GU) provided on the floor of a charging facility for charging.

### SUMMARY

An embodiment of the present disclosure can provide a battery-embedded device capable of providing power to a ground unit (GU) of an automatic charging device underbody (ACDU) system and a method for providing power using the same.

An example embodiment of the present disclosure can provide a battery-embedded device for supplying power to a ground unit (GU) in an automatic charging device underbody (ACDU) system, which can include a vehicle unit (VU) mounted on a vehicle with the GU installed on the ground and forming an electrical connection to the VU to transmit charging power to the vehicle. The battery-embedded device can include: an inlet to which a connector of a charger is connected; a power transmission line transmitting power provided from the charger to the GU through the inlet; a control pilot (CP) circuit for communication with the charger and the GU; a proximity detection (PD) circuit for detecting a connection to the connector of the charger; a rechargeable internal battery providing power to the GU; and a processor monitoring a voltage of the internal battery, and charging the internal battery when a state of charge (SOC) of the internal battery is smaller than a set, selected, or predetermined first reference.

In some example embodiments, the battery-embedded device may further include a switching mode power supply (SMPS) providing a charging voltage of the internal battery from the power transmission line.

In some example embodiments, the battery-embedded device may further include a first switch connecting the SMPS and the internal battery to each other in a turn-on state and disconnecting the SMPS and the internal battery from each other in a turn-off state.

In some example embodiments, the CP circuit may include a second switch connecting a CP input node and the processor to each other in a turn-on state and disconnecting the CP input node and the processor from each other in a turn-off state, and a third switch connecting the CP input node and a CP output node in a turn-on state and disconnecting the CP input node and the CP output node in a turn-off state.

In some example embodiments, the battery-embedded device may further include a fourth switch changing a signal value of a CP signal transmitted from the CP input node to the processor under a control of the processor.

In some example embodiments, the PD circuit may include a fifth switch connecting a PD input node and the processor to each other in a turn-on state and disconnecting the PD input node and the processor from each other in a turn-off state, and a sixth switch connecting the PD input node and a PD output node to each other in a turn-on state and disconnecting the PD input node and the PD output node from each other in a turn-off state.

In some example embodiments, the battery-embedded device may further include a seventh switch for turning on/off the power of the GU between the first switch and the internal battery. In some example embodiments, the battery-embedded device may further include a power line communication (PLC) modem connected in parallel to a CP line connected from the CP input node to the processor.

In some example embodiments, when the SOC of the internal battery is smaller than a set, selected, or predetermined first reference, the processor may operate the SMPS, and when the vehicle is not being charged, the processor may charge the internal battery after controlling the first switch, the second switch, and the fifth switch to be turned on, and controlling the third switch and the sixth switch to be turned off.

In some example embodiments, when the vehicle is being charged, the processor may charge the internal battery after controlling the fourth switch to be turned on after detecting a CP pulse width modulation (PWM) signal.

In some example embodiments, when the SOC of the internal battery exceeds a set, selected, or predetermined second reference, the processor may control the first switch, the second switch, and the fifth switch to be turned off, and control the third switch and the sixth switch to be turned on.

In some example embodiments, when the vehicle starts to be charged, the processor may control the first switch, the second switch, and the fifth switch to be turned off, and control the third switch and the sixth switch to be turned on.

An example embodiment of the present disclosure can provide a method for supplying power to a ground unit (GU) in an automatic charging device underbody (ACDU) system including a vehicle unit (VU) mounted on a vehicle with the GU installed on the ground and forming an electrical connection to the VU to transmit charging power to the vehicle, using a battery-embedded device including a processor, and the method can include: transmitting power provided from a charger to the GU through a power transmission line; monitoring an internal battery; determining whether a state of charge (SOC) of the internal battery is smaller than a set, selected, or predetermined first reference; charging the internal battery when it is determined that the SOC of the internal battery is smaller than the first reference; and providing power to the GU using the internal battery.

In some example embodiments, the charging of the internal battery may include operating a switching mode power supply (SMPS) providing a charging voltage of the internal battery from the power transmission line.

In some example embodiments, when the vehicle is not being charged, the charging of the internal battery may include: controlling a first switch to be turned on to connect the SMPS and the internal battery to each other; controlling a second switch to be turned on to connect a CP input node and the processor to each other; controlling a third switch to be turned on to connect a PD input node and the processor to each other; controlling a fourth switch to be turned off to disconnect the CP input node and a CP output node from each other; and controlling a fifth switch to be turned off to disconnect the PD input node and a PD output node from each other.

In some example embodiments, when the vehicle is being charged, the charging of the internal battery may include: detecting a CP pulse width modulation (PWM) signal; and controlling a sixth switch to be turned on.

In some example embodiments, the method may further include controlling the sixth switch to change a signal value of a CP signal transmitted from the CP input node to the processor.

In some example embodiments, the method may further include: controlling the first switch, the second switch, and the third switch to be turned off; and controlling the fourth switch and the fifth switch to be turned on, when it is determined that the SOC of the internal battery exceeds a set, selected, or predetermined second reference.

In some example embodiments, the method may further include: controlling the first switch, the second switch, and the third switch to be turned off; and controlling the fourth switch and the fifth switch to be turned on, when the vehicle starts to be charged.

In some example embodiments, the method may further include controlling a seventh switch to turn on/off the power of the GU.

### BRIEF DESCRIPTION OF THE DRAWINGS

FIG. 1 is a schematic diagram illustrating a battery-embedded device according to an example embodiment of the present disclosure.

FIG. 2 is a flowchart diagram illustrating a method for providing power according to an example embodiment of the present disclosure.

FIG. 3 is a schematic diagram illustrating a battery-embedded device according to an example embodiment of the present disclosure.

FIG. 4 is a diagram illustrating a method for providing power according to an example embodiment of the present disclosure.

### DETAILED DESCRIPTION OF ILLUSTRATIVE EMBODIMENTS

Hereinafter, example embodiments of the present disclosure will be described in detail with reference to the accompanying drawings, so that they can be easily carried out by those of ordinary skill in the art to which the present disclosure pertains. However, the present disclosure may be implemented in various different forms, and is not necessarily limited to the example embodiments described herein. To clearly explain the present disclosure, parts irrelevant to the description can be omitted from the drawings, and like elements can be denoted by like reference numerals throughout the specification.

Throughout the specification and the claims, when a certain part is referred to as “including” a certain component, this implies the potential presence of other components, not precluding the presence of other components, unless explicitly stated to the contrary. Terms including ordinal numbers such as “first” and “second” may be used to describe various components, but these components are not necessarily limited by such terms. Such terms can be used merely for the purpose of distinguishing one component from another component.

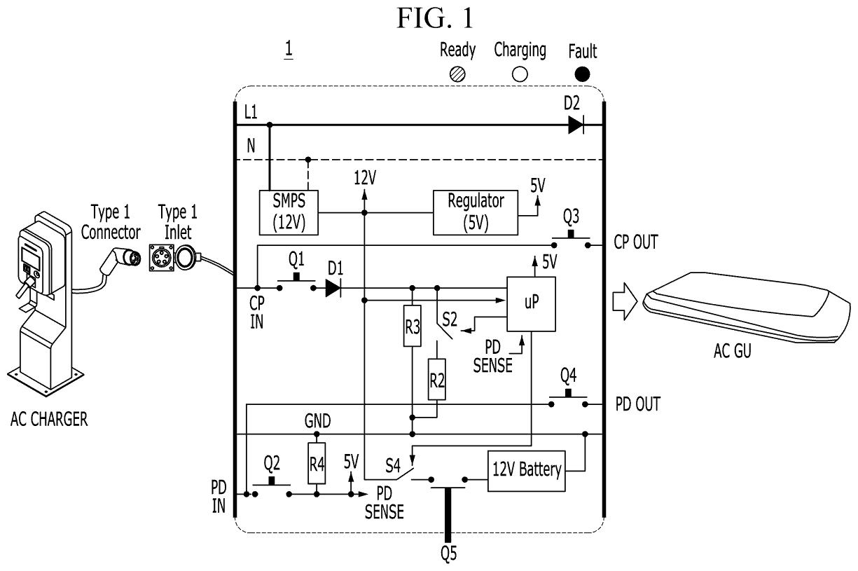

FIG. 1 is a diagram illustrating a battery-embedded device according to an example embodiment.

Referring to FIG. 1, a battery-embedded device 1 according to an example embodiment may be used in an automatic charging device underbody (ACDU) system. The automatic charging device underbody (ACDU) system may include a vehicle unit (VU) mounted on a vehicle and a ground unit (GU) installed on the ground and forming an electrical connection to the VU to transmit charging power to the vehicle. The battery-embedded device 1 may include an inlet, power transmission lines Li and N, a control pilot (CP) circuit, a proximity detection (PD) circuit, an internal battery, and a processor uP, any combination of or all of which may be in plural or may include plural components thereof. The internal battery can be a rechargeable battery, and may provide power to the GU.

A connector (e.g., a type 1 connector) of a charger (e.g., an AC charger) may be connected to the inlet, and the inlet may be, for example, a type 1 inlet. Type 1 is a type of slow charging method, and may be a single-phase standard in which communication is performed through CP. However, the scope of the present disclosure is not limited to Type 1, and the scope of the present disclosure may extend to Type 2, which is a three-phase standard, or other types of slow charging methods.

The power transmission lines Li and N may transmit power provided from the charger to the GU (e.g., AC GU) through the inlet. Although the power transmission lines are illustrated as a pair of power transmission lines Li and N because the single phase is exemplified in the present example embodiment, the number of lines may vary depending on the applicable standard.

The CP circuit may be a circuit for communication with the charger and the GU. The CP circuit may transmit and receive a CP signal to and from the charger and the GU, and the CP signal may include a signal for requesting start or stop of power transmission or controlling an amount of power.

The CP circuit may include switches Q1 and Q3. The switch Q1 may connect a CP input node CP IN and the processor uP to each other in a turn-on state, and may not connect the CP input node CP IN and the processor uP to each other in a turn-off state. The CP input node CP IN may be a node to which the CP signal transmitted from the charger through the inlet is input. The switch Q3 may connect the CP input node CP IN and a CP output node CP OUT to each other in a turn-on state, and may not connect the CP input node CP IN and the CP output node CP OUT to each other in a turn-off state. The CP output node CP OUT may be a node that transmits from which the CP signal is transmitted to the GU. Therefore, when the switch Q1 is in the turn-on state and the switch Q3 is in the turn-off state, the CP signal may be transmitted to the processor uP. On the other hand, when the switch Q1 is in the turn-off state and the switch Q3 is in the turn-on state, the CP signal may be transmitted to the GU in a bypass manner.

The battery-embedded device 1 may further include a switch S2. The switch S2 may change a signal value of the CP signal transmitted from the CP input node CP IN to the processor uP under a control of the processor uP.

The PD circuit may be a circuit for detecting a connection to the connector of the charger. The PD circuit may transmit and receive a PD signal to and from the charger and the GU, and the PD signal may include a signal indicating whether a PD contact of the connector and a PD port of the inlet are in contact with each other.

The PD circuit may include switches Q2 and Q4. The switch Q2 may connect a PD input node PD IN and the processor up to each other in a turn-on state, and may not connect the PD input node PD IN and the processor up to each other in a turn-off state. The PD input node PD IN may be a node to which a PD signal is input, the PD signal can indicate whether a PD contact of the connector and a PD port of the inlet are in contact with each other. On the other hand, the switch Q4 may connect the PD input node PD IN and a PD output node PD OUT to each other in a turn-on state, and may not connect the PD input node PD IN and the PD output node PD OUT to each other in a turn-off state. The PD output node PD OUT may be a node from which the PD signal is transmitted to the GU. Therefore, when the switch Q2 is in the turn-on state and the switch Q4 is in the turn-off state, the PD signal may be transmitted to the processor uP. On the other hand, when the switch Q2 is in the turn-off state and the switch Q4 is in the turn-on state, the PD signal may be transmitted to the GU in a bypass manner.

The battery-embedded device 1 may further include a switching mode power supply (SMPS). The SMPS may provide a charging voltage of the internal battery from the power transmission line. In some example embodiments, the charging voltage of the internal battery may be 12 V. The battery-embedded device 1 may further include a regulator. The regulator may provide a driving voltage of the processor up from a voltage signal output from the power transmission line through the SMPS. In some example embodiments, the driving voltage of the processor uP may be 5 V.

The battery-embedded device 1 may further include a switch S4. The switch S4 may connect the SMPS and the internal battery to each other in a turn-on state and not connect the SMPS and the internal battery to each other in a turn-off state.

The battery-embedded device 1 may further include a switch S5 between the switch S4 and the internal battery. The switch S5 may be used to power on/off the GU. That is, the switch S5 may switch the GU to be powered on in a turn-on state, and may switch the GU to be powered off in a turn-off state.

The processor uP may monitor the voltage of the internal battery. When a state of charge (SOC) of the internal battery is smaller than a set, selected, or predetermined first reference, the processor uP may control the internal battery to be charged.

Specifically, the processor uP may operate the SMPS when the SOC of the internal battery is smaller than the first reference. For example, when the SOC of the internal battery is smaller than 10%, the processor uP may operate the SMPS.

When the vehicle is not being charged, the processor uP may control the switch S4, the switch Q1, and the switch Q2 to be turned on, and control the switch Q3 and the switch Q4 to be turned off. That is, the processor uP may control the switch S4 to be turned on to connect the SMPS and the internal battery to each other, control the switch Q1 to be turned on to connect the CP input node CP IN and the processor uP to each other, control the switch Q2 to be turned on to connect the PD input node PD IN and the processor up to each other, control the switch Q3 to be turned off to disconnect the CP input node CP IN and the CP output node CP OUT from each other, and control the fifth switch Q4 to be turned off to disconnect the PD input node PD IN and the PD output node PD OUT from each other. Then, it may be started to charge the internal battery.

On the other hand, when the vehicle is being charged, the processor uP may control the switch S2 to be turned on after detecting a CP pulse width modulation (PWM) signal. Then, it may be started to charge the internal battery.

When the SOC of the internal battery exceeds a set, selected, or predetermined second reference, the processor uP may control the switch S4, the switch Q1, and the switch Q2 to be turned off, and control the switch Q3 and the switch Q4 to be turned on. For example, when the SOC of the internal battery exceeds 90%, the processor uP may control the switch S4 to be turned off to disconnect the SMPS and the internal battery from each other, control the switch Q1 to be turned off to disconnect the CP input node CP IN and the processor uP from each other, control the switch Q2 to be turned off to disconnect the PD input node PD IN and the processor uP from each other, control the switch Q3 to be turned on to connect the CP input node CP IN and the CP output node CP OUT to each other, and control the fifth switch Q4 to be turned on to connect the PD input node PD IN and the PD output node PD OUT.

Alternatively, when the vehicle starts to be charged, the processor uP may control the switch S4, the switch Q1, and the switch Q2 to be turned off, and control the switch Q3 and the switch Q4 to be turned on. That is, the processor uP may control the switch S4 to be turned off to disconnect the SMPS and the internal battery from each other, control the switch Q1 to be turned off to disconnect the CP input node CP IN and the processor uP from each other, control the switch Q2 to be turned off to disconnect the PD input node PD IN and the processor uP from each other, control the switch Q3 to be turned on to connect the CP input node CP IN and the CP output node CP OUT to each other, and control the fifth switch Q4 to be turned on to connect the PD input node PD IN and the PD output node PD OUT to each other.

In an example embodiment, R1 may be set to 1 k Ω, R2 may be set to 1.3 k Ω, R3 may be set to 2.74 kΩ, and R4 may be set to 330Ω, but the scope of the present disclosure is not necessarily limited to the specific resistance values.

According to an example embodiment, because a battery-embedded device in which a rechargeable internal battery is embedded can provide power to the GU, there can be no need to connect a separate external power source to the GU, and it can be possible to reduce restrictions at the time of building a charging infrastructure.

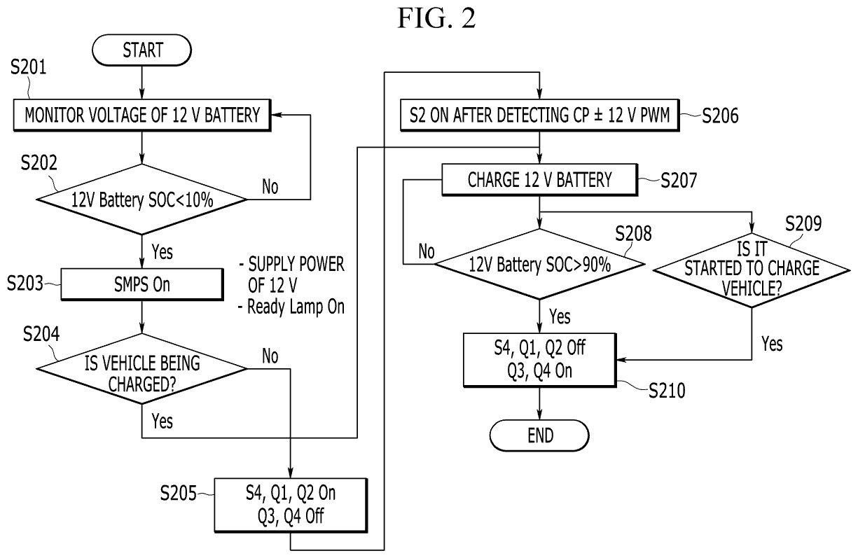

FIG. 2 is a flowchart diagram illustrating a method for providing power according to an example embodiment.

Referring to FIG. 2, a method for providing power according to an example embodiment may include monitoring a voltage of the internal battery (operation S201), and determining whether a SOC of the internal battery is smaller than a set, selected, or predetermined first reference (e.g., 10%) (operation S202).

When it is determined that the SOC of the internal battery is greater than or equal to the first reference, the method may proceed to operation S201.

When it is determined that the SOC of the internal battery is smaller than the first reference, the method may further include operating the SMPS (operation S203) and determining whether the vehicle is being charged (operation S204).

When it is determined that the vehicle is not being charged, the method may further include controlling the switch S4, the switch Q1, and the switch Q2 to be turned on, and controlling the switch Q3 and the switch Q4 to be turned off (operation S205), controlling the switch S2 to be turned on after detecting a CP PWM signal (operation S206), and charging the internal battery (operation S207).

On the other hand, when it is determined that the vehicle is being charged, the method may further include charging the internal battery (operation S207), following operation S204.

Subsequently, the method may include determining whether the SOC of the internal battery exceeds a set, selected, or predetermined second reference (e.g., 90%) (operation S208). When the SOC of the internal battery is smaller than the second reference, the method may proceed to operation S207.

When it is determined that the SOC of the internal battery exceeds the second reference, the method may further include controlling the switch S4, the switch Q1, and the switch Q2 to be turned off, and control the switch Q3 and the switch Q4 to be turned on (operation S210).

The method may include determining whether it is started to charge the vehicle (operation S209), following operation S207. When it is determined that it is started to charge the vehicle, the method may further include controlling the switch S4, the switch Q1, and the switch Q2 to be turned off, and control the switch Q3 and the switch Q4 to be turned on (operation S210).

A method for providing power according to an example embodiment has been described in more detail above or will be described in more detail below and may be referred to with reference to FIGS. 1, 3, and 4, and thus, redundant description will be omitted here.

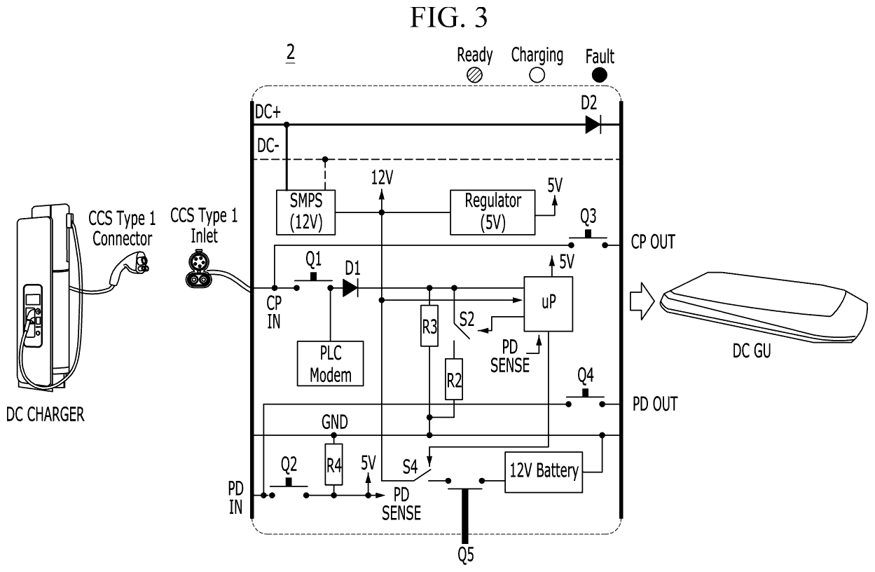

FIG. 3 is a diagram illustrating a battery-embedded device according to an example embodiment.

Referring to FIG. 3, a fast charging method can be applied to a battery-embedded device 2 according to an example embodiment, in contrast to the example of battery-embedded device 1 in FIG. 1. The battery-embedded device 2 may include an inlet, power transmission lines DC+ and DC-, a CP circuit, a PD circuit, an internal battery, and a processor uP, any combination of or all of which may be in plural or may include plural components thereof.

A connector (e.g., a CCS type 1 connector) of a charger (e.g., a DC charger) may be connected to the inlet, and the inlet may be, for example, a CCS type 1 inlet. CCS Type 1 is a type of fast charging method, and may be a standard in which communication is performed through a PLC modem. However, the scope of the present disclosure is not limited to CCS Type 1, and may also extend to CCS Type 2 or other types of fast charging methods.

The power transmission lines DC+ and DC− may transmit power provided from the charger to the GU (e.g., DC GU) through the inlet. Although the power transmission lines are illustrated as a pair of power transmission lines DC+ and DC− because the single phase is exemplified in the present example embodiment, the number of lines may vary depending on the applicable standard.

The battery-embedded device 2 may further include a PLC modem. The PLC modem may be connected in parallel to a CP line connected from the CP input node CP IN to the processor uP.

Concerning the other elements of the battery-embedded device 2, the above description made with reference to FIG. 1 may be referred to, unless contradicted, and thus redundant descriptions will be omitted here.

The processor uP may monitor a voltage of the internal battery. When an SOC of the internal battery is smaller than a set, selected, or predetermined first reference, the processor uP may control the internal battery to be charged. Specifically, the processor uP may operate the SMPS when the SOC of the internal battery is smaller than the first reference. For example, when the SOC of the internal battery is smaller than 10%, the processor uP may operate the SMPS.

When the vehicle is not being charged, the processor uP may control the switch S4, the switch Q1, and the switch Q2 to be turned on, and control the switch Q3 and the switch Q4 to be turned off. That is, the processor uP may control the switch S4 to be turned on to connect the SMPS and the internal battery to each other, control the switch Q1 to be turned on to connect the CP input node CP IN and the processor up to each other, control the switch Q2 to be turned on to connect the PD input node PD IN and the processor up to each other, control the switch Q3 to be turned off to disconnect the CP input node CP IN and the CP output node CP OUT from each other, and control the fifth switch Q4 to be turned off to disconnect the PD input node PD IN and the PD output node PD OUT from each other. Then, it may be started to charge the internal battery.

On the other hand, when the vehicle is being charged, the processor uP may control the switch S2 to be turned on after detecting a CP PWM signal. Then, it may be started to charge the internal battery.

When the SOC of the internal battery exceeds a set, selected, or predetermined second reference, the processor uP may control the switch S4, the switch Q1, and the switch Q2 to be turned off, and control the switch Q3 and the switch Q4 to be turned on. For example, when the SOC of the internal battery exceeds 90%, the processor uP may control the switch S4 to be turned off to disconnect the SMPS and the internal battery from each other, control the switch Q1 to be turned off to disconnect the CP input node CP IN and the processor up from each other, control the switch Q2 to be turned off to disconnect the PD input node PD IN and the processor uP from each other, control the switch Q3 to be turned on to connect the CP input node CP IN and the CP output node CP OUT to each other, and control the fifth switch Q4 to be turned on to connect the PD input node PD IN and the PD output node PD OUT.

Alternatively, when the vehicle starts to be charged, the processor uP may control the switch S4, the switch Q1, and the switch Q2 to be turned off, and control the switch Q3 and the switch Q4 to be turned on. That is, the processor uP may control the switch S4 to be turned off to disconnect the SMPS and the internal battery from each other, control the switch Q1 to be turned off to disconnect the CP input node CP IN and the processor uP from each other, control the switch Q2 to be turned off to disconnect the PD input node PD IN and the processor uP from each other, control the switch Q3 to be turned on to connect the CP input node CP IN and the CP output node CP OUT to each other, and control the fifth switch Q4 to be turned on to connect the PD input node PD IN and the PD output node PD OUT to each other.

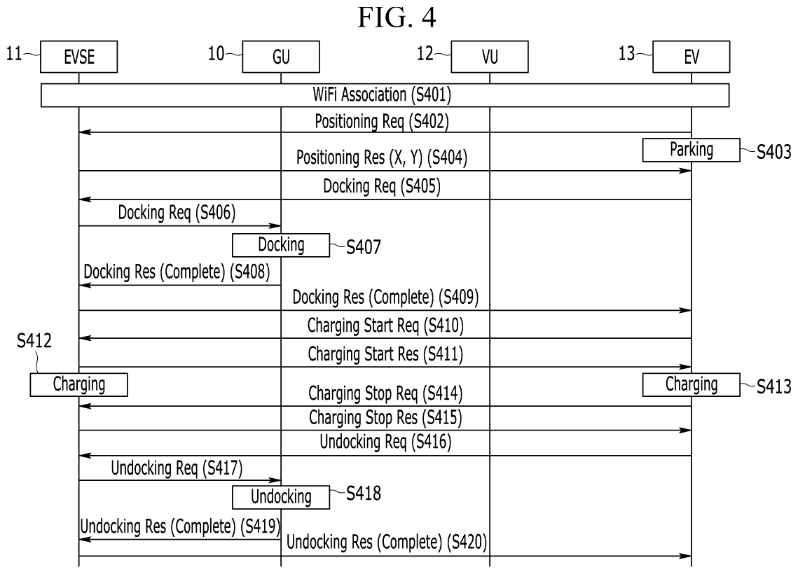

FIG. 4 is a diagram illustrating a method for providing power according to an example embodiment.

Referring to FIG. 4, a method for providing power according to an example embodiment may include: establishing a WiFi association between electric vehicle supply equipment (EVSE) 11, a GU 10, a VU 12, and an electric vehicle (EV) 13 (operation S401); the EV 13 transmitting a positioning request to the EVSE 11 (operation S402); the EV 13 performing parking (operation S403); and the EVSE 11 responding to the EV 13 with positioning coordinates (X, Y) (operation S404).

Further, the method for providing power may include: the EV 13 transmitting a docking request to the EVSE 11 (operation S405); the EVSE 11 transmitting a docking request to the GU 10 (operation S406); the GU 10 performing docking (operation S407); the GU 10 transmitting a docking response indicating the docking has been completed to the EVSE 11 (operation S408); and the EVSE 11 transmitting a docking response indicating the docking has been completed to the EV 13 (operation S409).

Further, the method for providing power may include: the EV 13 transmitting a charging start request to the EVSE 11 (operation S410); the EVSE 11 transmitting a charging start response to the EV 13 (operation S411); the EVSE 11 and the EV 13 performing charging (operations S412 and S413); the EV 13 transmitting a charging stop request to the EVSE 11 (operation S414); and the EVSE 11 transmitting a charging stop response to the EV 13 (operation S415).

Further, the method for providing power may include: the EV 13 transmitting an undocking request to the EVSE 11 (operation S416); the EVSE 11 transmitting an undocking request to the GU 10 (operation S417); the GU 10 performing undocking (operation S418); the GU 10 transmitting an undocking response indicating that the undocking has been completed to the EVSE 11 (operation S419); and the EVSE 11 transmitting an undocking response indicating that the undocking has been completed to the EV 13 (operation S420).

In a case where external power is separately provided to the GU depending on a charging infrastructure environmental condition, this may be a major restriction. In contrast, according to the example embodiments, because the battery-embedded device in which the rechargeable internal battery can be embedded and can provide power to the GU, there can be no need to separately connect external power to the GU, and it can be possible to reduce restrictions at the time of building a charging infrastructure. Furthermore, the battery-embedded device can be implemented in combination with a charger that supports international standards for electric vehicles, and can provide an infrastructure for automatically charging electric vehicles with improved user convenience.

Although example embodiments of the present disclosure have been described in detail above, the scopes of the present disclosure are not necessarily limited thereto, and various modifications and improvements made by those having ordinary knowledge in the art to which the present disclosure pertains using concepts of the present disclosure defined in the following claims also can fall within the scopes of the present disclosure.

What is claimed is:

1. A battery-embedded device configured to supply power to a ground unit (GU) in an automatic charging device underbody (ACDU) system including a vehicle unit (VU) mounted on a vehicle with the GU installed on a ground and forming an electrical connection to the VU to transmit charging power to the vehicle, the device comprising:
an inlet configured to connect to a connector of a charger;
a power transmission line configured to transmit power provided from the charger to the GU through the inlet;
a control pilot (CP) circuit configured to provide communication with the charger and the GU;
a proximity detection (PD) circuit configured to detect a connection to the connector of the charger;
a rechargeable internal battery configured to provide power to the GU; and
a processor configured to monitor a voltage of the internal battery, and charge the internal battery in response to a state of charge (SOC) of the internal battery being smaller than a first reference.

2. The device of claim 1, further comprising a switching mode power supply (SMPS) configured to provide a charging voltage of the internal battery from the power transmission line.

3. The device of claim 2, further comprising a first switch configured to connect the SMPS and the internal battery to each other in a turn-on state and configured to disconnect the SMPS and the internal battery from each other in a turn-off state.

4. The device of claim 3, wherein the CP circuit comprises:
a second switch configured to connect a CP input node and the processor to each other in a turn-on state and configured to disconnect the CP input node and the processor from each other in a turn-off state; and
a third switch configured to connect the CP input node and a CP output node in a turn-on state and configured to disconnect the CP input node and the CP output node in a turn-off state.

5. The device of claim 4, further comprising a fourth switch configured to change a signal value of a CP signal transmitted from the CP input node to the processor under a control of the processor.

6. The device of claim 5, wherein the PD circuit comprises:
a fifth switch configured to connect a PD input node and the processor to each other in a turn-on state and configured to disconnect the PD input node and the processor from each other in a turn-off state; and
a sixth switch configured to connect the PD input node and a PD output node to each other in a turn-on state and configured to disconnect the PD input node and the PD output node from each other in a turn-off state.

7. The device of claim 5, further comprising a seventh switch configured to turn on/off the power of the GU between the first switch and the internal battery.

8. The device of claim 4, further comprising a power line communication (PLC) modem connected in parallel to a CP line connected from the CP input node to the processor.

9. The device of claim 7, wherein the processor is configured to operate the SMPS in response to the SOC of the internal battery being smaller than a first reference, and
wherein, in response to the vehicle not being charged, the processor is configured to charge the internal battery after controlling the first switch, the second switch, and a fifth switch to be turned on, and controlling the third switch and a sixth switch to be turned off.

10. The device of claim 9, wherein, in response to the vehicle being charged, the processor is configured to charge the internal battery after controlling the fourth switch to be turned on after detecting a CP pulse width modulation (PWM) signal.

11. The device of claim 10, wherein, in response to the SOC of the internal battery exceeding a second reference, the processor is configured to control the first switch, the second switch, and the fifth switch to be turned off, and control the third switch and the sixth switch to be turned on.

12. The device of claim 10, wherein, in response to the vehicle starting to be charged, the processor is configured to control the first switch, the second switch, and the fifth switch to be turned off, and control the third switch and the sixth switch to be turned on.

13. A method for supplying power to a ground unit (GU) in an automatic charging device underbody (ACDU) system including a vehicle unit (VU) mounted on a vehicle with the GU installed on a ground and forming an electrical connection to the VU to transmit charging power to the vehicle, using a battery-embedded device including a processor, the method comprising:
transmitting power provided from a charger to the GU through a power transmission line;
monitoring an internal battery;
determining whether a state of charge (SOC) of the internal battery is smaller than a first reference;
charging the internal battery in response to determining that the SOC of the internal battery is smaller than the first reference; and
providing power to the GU using the internal battery.

14. The method of claim 13, wherein the charging of the internal battery comprises operating a switching mode power supply (SMPS) providing a charging voltage of the internal battery from the power transmission line.

15. The method of claim 14, wherein, in response to the vehicle not being charged, the charging of the internal battery comprises:
controlling a first switch to be turned on to connect the SMPS and the internal battery to each other;
controlling a second switch to be turned on to connect a CP input node and the processor to each other;
controlling a third switch to be turned on to connect a PD input node and the processor to each other;
controlling a fourth switch to be turned off to disconnect the CP input node and a CP output node from each other; and
controlling a fifth switch to be turned off to disconnect the PD input node and a PD output node from each other.

16. The method of claim 15, wherein, in response to the vehicle being charged, the charging of the internal battery comprises:
detecting a CP pulse width modulation (PWM) signal; and
controlling a sixth switch to be turned on.

17. The method of claim 16, further comprising controlling the sixth switch to change a signal value of a CP signal transmitted from the CP input node to the processor.

18. The method of claim 16, in response to determining that the SOC of the internal battery exceeds a second reference, further comprising:
controlling the first switch to be turned off;
controlling the second switch to be turned off;
controlling the third switch to be turned off;
controlling the fourth switch to be turned on; and
controlling the fifth switch to be turned on.

19. The method of claim 16, in response to the vehicle starting to be charged, further comprising:
controlling the first switch to be turned off;
controlling the second switch to be turned off;
controlling the third switch to be turned off;
controlling the fourth switch to be turned on; and
controlling the fifth switch to be turned on.

20. A method for supplying power to a ground unit (GU) in an automatic charging device underbody (ACDU) system including a vehicle unit (VU) mounted on a vehicle with the GU installed on a ground and forming an electrical connection to the VU to transmit charging power to the vehicle, using a battery-embedded device including a processor, the method comprising:
transmitting power provided from a charger to the GU through a power transmission line;
monitoring an internal battery;
determining whether a state of charge (SOC) of the internal battery is smaller than a first reference;
charging the internal battery in response to determining that the SOC of the internal battery is smaller than the first reference;
providing power to the GU using the internal battery; and
controlling a switch to turn on/off the power of the GU.
